(19) United States
(12) Patent Application Publication
(10) Pub. No.: US 2004/0152798 A1
(43) Pub. Date: Aug. 5, 2004

(54) Photo-initiator compositions

(76) Inventors: Peter Weissman, Woodtsock, GA (US); Rosalyn Waldo, Woodstock, GA (US); Larisa Kagansky, Atlanta, GA (US); Udaykumar Patel, Marietta, GA (US)

Correspondence Address: WENDEROTH, LIND & PONACK, L.L.P., 2033 K STREET N. W., SUITE 800, WASHINGTON, DC, 20006-1021, US

(21) Appl. No.: 10/476,150

(22) PCT Filed: Apr. 22, 2002
(86) PCT No.: PCT/EP02/04403

(30) Foreign Application Priority Data
Apr. 27, 2001 (EP) 01110473.4

(51) Int. Cl. C08F 2/46

(52) U.S. Cl. 522/8

(57) ABSTRACT

Photo-initiator blends suitable for radiation curable ink formulations are disclosed which comprise a mixture of three or more photo-initiators, the mixture being a liquid at a temperature at or below ambient; the mixture comprising: (a) a first photo-initiator comprising an optionally substituted hydroxyC1-10 alkylC6-18aryl ketone which is liquid at ambient temperature; (b) a second photo-initiator comprising an optionally substituted hydroxy(cycliC3-10alkyl)C6-18aryl ketone which is solid at ambient temperature; and (c) one or more of the following photo-initiators each of which may be optionally substituted:an alpha aminoacetophenone, a C6-18aryl(((C1-10 alkyl)1-4C6-18arylcarbonyl))1-3 phosphine oxide, a benzophenone; a benzophenone derivative and/or a hydra-carob (optionally alkyl or aryl) amino benzoate; where, (i) the first photo-initiator (a) and the second photo-initiator (b) are present in the mixture in a weight ratio of from about 0.8 to about 1.2, (ii) the first photo-initiator (a) and the second photo-initiator (b) together comprise from about 15 to about 85 percent by weight of the total mixture.

The present invention relates to improved liquid compositions which have use for example as photo-initiators, such as in inks suitable for use with radiation cured polymers.

Inks for use in radiation cured polymers require a photo-initiator to aid the start of polymerization. It is often necessary or desirable to blend different photo-initiators together in a mixture to improve the sensitive of the photo-initiator over a wide range of different wavelengths so the resultant ink can be more readily cured using incident radiation comprising many different wavelengths.

In general, liquid photo-initiators and blends thereof are more convenient to use. Prior art photo-initiator blends are prepared by blending at high temperatures in an oven to keep the mixture liquid. However this is difficult to do and can causes the resultant photo-initiator blends to be less stable (i.e. solid precipitates may form when the photo-initiator is left for extended periods). It would be desirable to provide photo-initiator compounds and/or blends with improved stability; which are substantially liquid at ambient temperatures or lower, which can be mixed together more readily that prior art blends; which are easier to use and/or which can be shipped more easily

This invention relates to further aspects of the applicant's co-pending application EP 01110473.4 the contents of which for convenience are hereby described herein and also incorporated herein by reference.

Surprisingly the applicant has discovered that certain synergistic mixtures of photo-initiators form liquid blends, which overcome some or all of the disadvantages, described herein.

Therefore broadly in accordance with the present invention there is provided a mixture of three or more photo-initiators, said mixture being a liquid at a temperature at or below ambient; the mixture comprising:

(a) a first photo-initiator comprising an optionally substituted hydroxyC₁₋₁₀ alkylC₆₋₁₈aryl ketone which is liquid at ambient temperature;

(b) a second photo-initiator comprising an optionally substituted hydroxy(cycloC₃₋₁₀alkyl)C₆₋₁₈aryl ketone which is solid at ambient temperature; and

c) One or more of the following photo-initiators each of which may be optionally substituted:

an alpha aminoacetophenone, a C₆₋₁₈aryl(((C₁₋₁₀alkyl)₁₋₄C₆₋₁₈arylcarbonyl))₁₋₃ phosphine oxide, a benzophenone; a benzophenone derivative and/or a hydrocarbo (optionally alkyl or aryl) amino benzoate; where.

(i) the first photo-initiator (a) and the second photo-initiator (b) are present in the mixture in a weight ratio of from about 0.8 to about 1.2,

(ii) the first photo-initiator (a) and the second photo-initiator (b) together comprise from about 15 to about 85 percent by weight of the total mixture.

Preferably ambient temperature denotes a temperature of 20° C.

Preferably the first photo-initiator (a) comprises hydroxyC₁₋₆alkylC₆₋₁₂aryl ketone, more preferably hydroxyC₁₋₄ alkyl phenyl ketone; most preferably 2-hydroxy-2-methyl-1-phenyl-1-propanone (such as that available commercially from CIBA as a clear liquid under the trade name “Darocur 1173”). p Preferably the second photo-initiator (b) comprises hydroxy(cycloC₃₋₆alkyl)C₆₋₁₂aryl ketone; most preferably hydroxy(cycloC₃₋₆alkyl)phenyl ketone; most preferably 1-hydroxycyclohexyl phenyl ketone (such as that available commercially from CIBA as a white solid under the trade name “Irgacure 184”).

Preferably the third photo-initiator (c) comprises C₆₋₁₂aryl(((C₁₋₆alkyl)₂₋₃C₆₋₁₂arylcarbonyl)₁₋₂ phosphine oxide; more preferably phenyl((C₁₋₄alkyl)₃benzoyl)₂ phosphine oxide; most preferably phenyl bis(2,4,6-trimethyl benzoyl) phosphine oxide (such as that available commercially from CIBA as a solid under the trade name “Irgacure 819”).

In other preferred embodiments, the third photo-initiator (c) is benzophenone or a benzophenone derivative.

Preferred benzophenone derivatives are EBECRYL P36 (an acrylated derivative of benzophenone) or EBECRYUL P37, (a solid benzophenone derivative) both available commercially from UCB chemicals.

Preferably the weight ratio of the first photo-initiator (a) to the second photo-initiator (b) is from about 0.9 to about 1:1, more preferably is about 1.0.

Preferably the first photo-initiator (a) and the second photo-initiator (b) together comprise from about 60% to about 75% by weight of the total mixture.

Preferably the third photo-initiator (c) comprises from about 25% to about 40% by weight of the total mixture.

The terms ‘optional substituent’ and/or ‘optionally substituted’ as used herein (unless followed by a list of other substituents) signifies the one or more of following groups (or substitution by these groups): carboxy, sulpho, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulphonyl if directly attached to each other represent a sulphamoyl radical). Preferred optional substituents comprise: carboxy, sulpho, hydroxy, amino, mercapto, cyano, methyl and/or methoxy.

The term ‘hydrocarbo’ may also be used herein to replace other terms such as alkyl or aryl herein where the context allows. A hydrocarbo group denotes any univalent or multivalent moiety (optionally attached to one or more other moieties) which consists of one or more hydrogen atoms and one or more carbon atoms and may comprise saturated, unsaturated and/or aromatic moieties. Hydrocarbo groups may comprise one or more of the following groups. Hydrocarbyl groups comprise univalent groups formed by removing a hydrogen atom from a hydrocarbon. Hydrocarbylene groups comprise divalent groups formed by removing two hydrogen atoms from a hydrocarbon the free valencies of which are not engaged in a double bond. Hydrocarbylidene groups comprise divalent groups (represented by “R₂C═”) formed by removing two hydrogen atoms from the same carbon atom of a hydrocarbon, the free valencies of which are engaged in a double bond. Hydrocarbylidyne groups comprise trivalent groups (represented by “RC≡”), formed by removing three hydrogen atoms from the same carbon atom of a hydrocarbon the free valencies of which are engaged in a triple bond. Hydrocarbo groups may also comprise saturated carbon to carbon single bonds: unsaturated double and/or triple carbon to carbon bonds (e.g. alkenyl, and/or alkynyl groups respectively) and/or aromatic groups (e.g. aryl) and where indicated may be substituted with other functional groups.

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group, which comprises a chain of three or more atoms, signifies a group in which the chain wholly or in part may be linear, branched and/or form a ring (including spiro and/or fused rings). The total number of certain atoms is specified for certain substituents for example C_{1-N}hydrocarbo, signifies a hydrocarbo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable or effective.

Unless the context clearly indicates otherwise, as used herein plural forms of the terms herein are to be construed as including the singular form and vice versa.

The term “comprising” as used herein will be understood to mean that the list following is non-exhaustive and may or may not include any other additional suitable items, for example one or more further feature(s), component(s), ingredient(s) and/or substituent(s) as appropriate.

The term “effective” and/or “suitable” (for example with reference to the processes, uses, products, materials, formulations, compositions, compounds, monomers, oligomers, polymer precursors and/or polymers used in and/or of the present invention) will be understood to denote utility in any one or more of the following uses and/or applications: preparation and/or use of radiation curable formulations, such as inks, and/or photo-initiators for use with such formulations.

Such utility may be direct where the material has the required properties for the aforementioned uses and/or indirect where the material has use as a synthetic intermediate and/or diagnostic tool in preparing materials of direct utility. As used herein the term “suitable” also denotes that a functional group is compatible with producing an effective product.

The substituents on a repeating unit in any polymers herein may be selected to improve the compatibility of the materials with the polymers and/or resins in which they may be formulated and/or incorporated for the aforementioned uses. Thus, the size and length of the substituents may be selected to optimise the physical entanglement or interlocation with the resin or they may or may not comprise other reactive entities capable of chemically reacting and/or cross-linking with such other resins.

Certain moieties, species, groups, repeat units, compounds, oligomers, polymers, materials, mixtures, compositions and/or formulations which comprise and/or are used in some or all of the invention as described herein may exist as one or more different forms such as any of those in the following non exhaustive list: stereoisomers (such as enantiomers (e.g. E and/or Z forms), diastereoisomers and/or geometric isomers); tautomers (e.g. .keto and/or enol forms), conformers, salts, zwitterions, complexes (such as chelates, clathrates, interstitial compounds, ligand complexes, organometallic complexes, non-stoichiometric complexes, solvates and/or hydrates); isotopically substituted forms, polymeric configurations [such as homo or copolymers, random, graft or block polymers, linear or branched polymers (e.g. star and/or side branched), cross-linked and/or networked polymers, polymers obtainable from di and/or tri-valent repeat units, dendrimers, polymers of different tacticity (e.g. isotactic, syndiotactic or atactic polymers)]; polymorphs (such as interstitial forms, crystalline forms and/or amorphous forms), different phases, solid solutions; combinations thereof and/or mixtures thereof. The present invention comprises and/or uses all such forms, which are effective.

In another aspect of the present invention provides a composition and/or formulation obtained and/or obtainable by any of the processes of the invention as described herein.

A further aspect of the invention comprises a method of preparing an ink comprising the steps of mixing a composition and/or formulation of the invention as described herein with a suitable carrier medium and/or grinder.

A still other aspect of the present invention provides an ink obtained and/or obtainable by the preceding method. Preferred inks are those suitable for use in lithographic printing for example for graphic art applications.

A still further aspect of the invention provides use of a composition and/or formulation of the invention to make an ink, preferably a lithographic ink.

Another further aspect of the invention provides use of an ink of the invention (preferably a lithographic ink) to print an article and/or an article so printed.

Other aspects of the present invention may be given in the claims.

The invention will now be illustrated by the following non-limiting examples and tests, which are by way of illustration only. Unless otherwise indicated herein all the test results and properties herein were performed using conventional methods well known to those skilled in the art.

The following ingredients are used in the Examples herein:

2-Hydroxy-2-methyl-1-phenyl-1-propanone (CAS no. 7473-98-5) which is a photo-initiator available commercially from CIBA as a clear liquid under the trade name “Darocur 1173”.

1-Hydroxycyclohexyl phenyl ketone (CAS no. 947-19-3) which is a photo-initiator available commercially from CIBA as a white solid under the trade name “Irgacure 184”.

Phenyl bis(2,4,6-trimethyl benzoyl) phosphine oxide (CAS no. 162881-26-7) which is a photoinitiator available commercially from CIBA as a solid under the trade name “Irgacure 819”.

2-Benzyl-2-(dimethylamino)-1-[4-(4-morpholinyl) phenyl)-1-butanone (CAS no. 119313-12-1) which is a photo-initiator available commercially from CIBA as a yellow solid under the trade name “Irgacure 369“.

Ethyl 4-dimethylaminobenzoate (CAS no. 10287-53-3) which is a photo-initiator available commercially as a white solid under the trade name “Quanticure EPD”.

2-Isopropylthioxanthone (CAS no. 5495-84-1) which is a photo-initiator available commercially as a yellow solid under the trade name “Quanticure ITX”.

TMPEOTA which denotes trimethylolpropane ethoxy triacrylate (CAS no. 28961-43-5) also known as poly(oxy-1,2-ethanediyl), alpha.-hydra-omega.-[(1-oxo-2-propenyl)oxyl],-ether with 2-ethyl-2-(hydroxymethyl)-1;3-propanediol (3:1).

DPGDA which denotes dipropylene glycol diacrylate (CAS no. 57472-68-1) also known as 2-propenoic acid, oxybis(methyl-2,1-ethanediyl) ester.

BDK, which denotes a benzil dimethyl ketal of formula

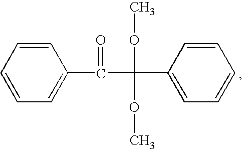

which is a solid photo-initiator suitable for UV-curable unsaturated polyester and acrylate, based coatings and is available commercially from, for example, ChemFirst Fine Chemicals.

Benzophenone (CAS no. 119-61-9) is a known photo-initiator available commercially from UCB Chemicals as a white solid under the trade name “Ebecryl BPO”.

MEHQ which denotes methyl hydroquinone (CAS no. 150-76-5), an inhibitor also known as the monomethyl ether of hydroquinone, available commercially from Aldrich Chemicals.

Acrylated polyester polymer having an average of 5 to 6 acrylate groups per molecule, which is available commercially from UCB Chemicals under the trademark Ebecryl 870.

Polyester acrylate oligomer grinding vehicle for flexographic ink, which is available commercially from UCB Chemicals under the trade, mark Ebecryl 812.

Carbon black pigment available commercially from Columbian Chemicals under the trade name Raven 450.

Copper phthalocyanine colorant available commercially from Ciba, under the trade name Irgalite Blue LGLD.

Magenta colorant available commercially from Ciba, under the trade name Irgalite Rubine L4BD.

Yellow colorant available commercially from Ciba under the trade name Irgalite Yellow BAW.

Various liquid photo-initiator blends were prepared by mixing the components according to Table 1.

TABLE 1
(photo-initiator blends)

| Components | | Ex | | Ex | | | Comp | Comp |
|---|---|---|---|---|---|---|---|---|
| (%) | Ex 1 | 2 | Ex 3 | 4 | Ex 5 | Ex 6 | A | B |
| Darocur 1173 | 37.5 | 32 | 31.5 | 31 | 30.5 | 30 | 27.5 | 25 |
| Irgacure 184 | 37.5 | 32 | 31.5 | 31 | 30.5 | 30 | 27.5 | 25 |
| Irgacure 819 | 25.0 | 36 | 37 | 38 | 39 | 40 | 45 | 50 |

Examples 1 to 6 were prepared on Day 1 by blending the components together in the amounts given in Table 1, and each example was placed in a refrigerator on Day 2. The examples were then observed for stability i.e. for the presence of solid precipitates. The examples were transferred into a freezer at 11:00 am on day 14 (i.e. between observations 14(a) and 14(b)). The examples were removed from the freezer on day 23 when the experiment was ended. The observations made are given in Tables 2A and 2B for Examples 2 to 6 (Example 1 was not tested) and comparative examples Comp A and B. It can be seen that the blends were unsatisfactorily where the Irgacure 819 was present in an amount of 45% by weight or greater as significant crystallization was observed from 14 days onwards during the test (Comp A & B). In comparison Examples 2 to 6 show none or minimal crystallization during the test indicating excellent to good long tern stability.

Although the liquid Darocur 1173 is well known to be a good solvent previously it has only been possible to solubilize 20% by weight of other photo-initiators therein such as the Irgacure 819 phosphine oxide. Surprisingly it has been found that adding an approximately equal amount by weight of the solid Irgacure 184 leads to a mixture with synergistic and unexpected properties as the new mixture is capable of solubilizing 25% or more of other photo-initiators such as the Irgacure 819 (as shown in Tables 2A to 2B). In the Tables 2A & 2B a check mark indicates no solid precipitates were observed i.e. the blend was stable.

TABLE 2A

| | Ex | | | | Ex | | |
|---|---|---|---|---|---|---|---|
| Day | 2 | Ex 3 | Ex 4 | Ex 5 | 6 | Comp A | Comp B |
| 3 | √ | √ | √ | √ | √ | √ | √ |
| 7 | √ | √ | √ | One tiny | √ | Almost | Beginning |
| | | | | speck at | | un- | crystallin. |
| | | | | bottom of | | noticeable | |
| | | | | jar | | flakes | |
| 8 | √ | √ | √ | One speck | √ | Slightly | Beginning |
| | | | | at bottom | | hazy, | crystalln. |
| | | | | of jar | | flakes | |
| 9 | √ | √ | √ | One speck | √ | Potential | Beginning |
| | | | | at bottom | | crystalln. | crystalln. few |
| | | | | of jar | | Occurring | spec at |
| | | | | | | | bottom of jar |
| 10 | √ | One | √ | One speck | √ | Potential | Beginning |
| | | tiny | | at bottom | | crystalln. | crystalln.; a |
| | | speck | | of jar | | occurring | few tiny |
| | | at | | | | | specks settled |
| | | bottom | | | | | on the bottom |
| | | of jar | | | | | of jar |
| 11 | √ | One | One | Speck at | √ | Potential | Beginning |
| | | tiny | tiny | bottom of | | crystalln. | crystalln.; a |
| | | speck | speck | jar | | occurring | few tiny |
| | | at | at | | | | specks settled |
| | | bottom | bot- | | | | at the bottom |
| | | of jar | tom | | | | of jar |
| | | | of jar | | | | |

TABLE 2B

| Day | Ex 2 | Ex 3 | Ex 4 | Ex 5 | Ex 6 | Comp A | Comp B |
|---|---|---|---|---|---|---|---|
| 14 | √ | One tiny | One | Crystal | √ | Potentially | Several |
| (a) | | crystal | minute | forming | | starting to | crystals |
| | | forming | speck | obvious | | crystallise | settling on |
| | | | | speck | | throughout | bottom only |
| 14 | √ | One tiny | One | Crystal | √ | Potentially | Several |
| (b) | | crystal | minute | forming | | starting to | crystals |
| | | forming | speck | larger | | crystallise | settling on |
| | | | | speck | | throughout | bottom only |
| 15 | √ | One tiny | One | Crystal | √ | Potentially | Several |
| | | crystal | minute | forming | | starting to | crystals |
| | | forming | speck | larger | | crystallise | settling on |
| | | | | speck | | throughout | bottom only |
| 16 | √ | One tiny | One | Crystal | √ | Potentially | Several |
| | | crystal | minute | forming | | starting to | crystals |
| | | forming | speck | larger | | crystallise | settling on |
| | | | | speck | | throughout | bottom only |
| 17 | √ | One tiny | One | Crystal | √ | Potentially | Several |
| | | crystal | minute | forming; | | starting to | crystals |
| | | forming | speck | larger | | crystallise | settling on |
| | | | | speck | | throughout | bottom only |
| 22 | Perfect | 2-3 | One | One | * | Crystallised, | Multiple |
| | | specks | extremely | obvious | | not good | specs on |
| | | crystallin. | hard to | spec | | | bottom, |
| | | occurring | identify | crystalln. | | | crystalln. |
| | | | spec. | has begun | | | has begun. |
| | | | Possibly | | | | |
| | | | beginning | | | | |
| | | | crystalln. | | | | |

*Clear, however the appearance of air bubbles or minute specks

The performance of photo-initiator blends of the present invention for dark colour systems was compared to conventional photo-initiators.

Various conventional pigment concentrates (Examples B to D) were prepared as follows and with reference to Table 3. Ebecryl 812 was manually blended with pigment at a 30% level, then was continuously passed through a three-roll mill to make a pigment concentrate having a desired Hegman grind value.

TABLE 3
Pigment Concentrates.

| | Ex C | Ex D | Ex E | Ex F |
|---|---|---|---|---|
| Component | Weight %/g | Weight %/g | Weight %/g | Weight %/g |
| Ebecryl 812 | 70.0%/ | 70.0%/ | 70.0%/ | 70.0%/ |
| | 140.0 g | 140.0 g | 140.0 g | 140.0 g |
| Carbon Black Raven 450 | 30.0%/60.0 g | — | — | — |
| Irgalite Blue LGLD | — | 30.0%/60.0 g | — | — |
| Irgalite Rubine L4BD | — | — | 30.0%/60.0 g | — |
| Irgalite Yellow BAW | — | — | — | 30.0%/60.0 g |

For comparison a formulation of the invention (Example 7, see Table 4) using liquid photo-initiator blends of the invention and a prior art formulation (Comp G, see Table 5) using a conventional liquid photo-initiator were each used as letdown vehicles (diluent formulations) to make inks. In table 4 ”Liquid PI system” denotes any one of the liquid photo-initiator blends of the invention given in Examples 1 to 6 herein.

Each diluent was added at 50% to the pigment concentrations in Table 3 and was manually blended together and then dispersed for 15 minutes using the Premier Mill Dispersator to make a final ink. The final ink compositions are given in Table 6.

TABLE 4
(Example 7)

| Components | Weight (%/g) |
|---|---|
| TMPEOTA | 59.9/269.6 |
| DPGDA | 24.0/108.0 |
| Liquid PI system | 16.0/72.0 |
| MEHQ | 0.1/0.45 |

TABLE 5
(Comp G).

| Components | Weight (g) |
|---|---|
| TMPEOTA | 59.9 |
| DPGDA | 24.0 |
| Iragcure-369 | 2.5 |
| Quanticure EPD | 2.5 |
| Quanticure ITX | 2.5 |
| BDK | 2.5 |
| MEHQ | 0.1 |

TABLE 6
(Ink formulations.)

| Components | Ex H | Ex 8 | Ex J | Ex 9 | Ex K | Ex 10 | Ex L |
|---|---|---|---|---|---|---|---|
| Pigment Ex A | 50.0 | — | — | — | — | — | — |
| Pigment Ex B | — | 50.0 | 50.0 | — | — | — | — |
| Pigment Ex C | — | — | — | 50.0 | 50.0 | | |
| Pigment Ex D | — | — | — | — | — | 50.0 | 50.0 |
| Diluent Ex 7 | — | 50.0 | — | 50.0 | — | 50.0 | — |
| Diluent Comp G | 50.0 | — | 50.0 | — | 50.0 | — | 50.0 |

The viscosities of the final inks were measured twenty-four hours after preparation using the Haake RS150 RheoStress rheometer. These inks were drawn down onto a polypropylene substrate (applied on outside & wiped with isopropyl) using a Cavanagh proofer and UV cured using the fusion unit equipped with one lamp (600 WPI) 75%, 100 RPM at 190.3 mJ/cm². The ink coatings were shiny and were examined for colour, adhesion and other properties. The results indicate that inks containing the photo-initiator blends of the invention perform comparably to the prior art, with few major differences in the physical properties or the performance. The blends of the invention are easier to prepare and use.

The following two photo-initiator blends of the invention (Examples 11 and 12) were identified from solubility data as of special use for Inks with dark colours.

Example 11 is a photo-initiator blend of the invention comprising Quantacure EPD, Ebecryl BPO, Irgacure 369, Irgacure 184, Quantacure ITX, and Darocur 1173; and

Example 12 is a photo-initiator blend of the invention comprising Quantacure EPD, Irgacure 369, Irgacure 184, Quantacure ITX, and Darocur 1173 (i.e. without the Ebecryl EPO). Control formulations were made comprising the photo-initiator blends of Examples 11 or 12 with an acrylated polyester polymer having an average of 5 to 6 acrylate groups per molecule (available commercially from UCB Chemicals under the trade mark Ebecryl 870). These formulations were evaluated for reactivity and lithographic properties

Inks in various colors and black were prepared by adding the photo-initiator blends of Examples 11 and 12 in amounts of 10% and 12% by weight of the ink. In addition to reactivity, basic lithographic properties such as tack and water balance were also measured. The results are given in Table 7 below where Comp M denotes a magenta ink of a similar formulation containing 10% of a conventional photo-initiator. Tack was measured using a Thwing-Albert Electronic Inkometer for 3 minutes at 1200 rpm and at a temperature of 32° C.

TABLE 7
(more inks)

| | | Water Balance | Reactivity, mJ/cm² | |
|---|---|---|---|---|
| | Tack, gm | Avg. % retained | 1-400 watts/in lamp | |
| Comp M | 12.5 | 24.2 | 275 | |
| Inks using Ex 11 | | | 10% | 12% |
| Black | 12.3 | 19.2 | 295 | 95 |
| Cyan | 12.9 | 26.8 | 296 | 76 |
| Inks using Ex 12 | | | 10% | 12% |
| Black | 13.9 | 20.4 | 108 | 296 |
| Magenta | 14.5 | 29.6 | 209 | 282 |
| Cyan | 13.2 | 26.8 | 522 | 70 |

Inks using 10% of the photo-initiator blend of Example 11 exhibited reactivities comparable to the Comp M. Increasing the photo-initiator level to 12% caused a 71% increase (on average) in reactivity for the black and cyan inks. Inks using the photo-initiator blend of Example 12 exhibited significant reactivity increases with the black and magenta inks compared to Comp M, however the cyan ink exhibited very slow reactivity. An increase in the photo-initiator level (to 12%) caused a significant increase in the cyan ink's reactivity.

Ink tacks were similar regardless of photo-initiator. Inks tested with these photo-initiator blends (Ex 11 & 12) did not show adverse effects on fountain solution conductivity (and thus printability) or on water balance or pick-up. Regardless of photo-initiator colored inks tended to retain more water, while black inks tended to retain less. On the basis of reactivity responsiveness, inks made from Example 11 appear to be particularly suitable for lithographic applications.

The following Examples 13 to 15 and the data in Table 8 to 10 show with mixtures of Irgacure 184 and Darocur 1173 one obtains particularly stable liquid blends. The standard letdown vehicle consists of TUPEOTA (59.9%), DPGDA (24%), ITX 4 (25%), BDK 4 (25%), EPD 4 (25%), Irg 369 4 (25%), and MEHQ (0.1%).

TABLE 8

| | EPD | BPO | Irg | Irgacure | Darocur | Stability in |
|---|---|---|---|---|---|---|
| | (g) | (g) | 369 (g) | 184 (g) | 1173 (g) | Refrigerator |
| Ex 13 | 31.3 | 25 | 17.8 | 10.7 | 10.7 | 9 Days |
| Comp N | 31.3 | 25 | 17.8 | 0 | 10.7 | 4 Days |
| Comp O | 31.3 | 25 | 17.8 | 10.7 | 0 | 0 days |
| Comp P | 31.3 | 25 | 17.8 | 0 | 0 | 3 days |

Example 13 demonstrates the synergistic affect on solubility of using both Irgacure 184 together with Darocur 1173 to form a ambient temperature stable system that contains EPD, Irgacure 369 and BPO. The samples of Example 13 were made by weighing the individual ingredients into a glass container, and heating them in an oven at 60° C. Then samples were mixed by hand until 100 percent of the components were in a liquid state and the mixture was homogeneous. The samples were then allowed to cool to room temperature, and subsequently transferred to a refrigerator set at 11° C. The stability in days was the amount of time that elapsed in the refrigerator before any crystallization or other instability was noted in the mixture. The data in Table 8 clearly demonstrates the superior stability of the mixtures when Irgacure 184 and Darocur 1173 are used together.

TABLE 9

| | EPD | Irg 369 | Irgacure | | Darocur | Stability in |
|---|---|---|---|---|---|---|
| | (g) | (g) | 184 (g) | ITX (g) | 1173(g) | Refrigerator |
| Ex 14 | 31.3 | 17.8 | 10.7 | 4.5 | 10.7 | 10 days |
| Comp Q | 31.3 | 17.8 | 0 | 4.5 | 10.7 | 1 |
| Comp R | 31.3 | 17.8 | 10.7 | 4.5 | 0 | 3 days |
| Comp S | 31.3 | 17.8 | 0 | 4.5 | 0 | 3 days |

Example 14 demonstrates the synergistic affect on solubility of using both Irgacure 184 together with Darocur 1173 to form a ambient temperature stable system that contains EPD, Irgacure 369 and ITX. The samples of Example 14 were made by weighing the individual ingredients into a glass container, and heating them in an oven at 60° C. Then samples were mixed by hand until 100 percent of the components were in a liquid state and the mixture was homogeneous. The samples were then allowed to cool to room temperature, and subsequently transferred to a refrigerator set at 11° C. The stability in days was the amount of time that elapsed in the refrigerator before any crystallization or other instability was noted in the mixture. The data in Table 9 clearly demonstrate the superior stability of the mixtures when Irgacure 184 and Darocur 1173 are used together.

TABLE 10

| | EPD/ | BPO/ | Irg | Irgacure | ITX/ | Darocur | Stability in |
|---|---|---|---|---|---|---|---|
| | g | g | 369/g | 184/g | g | 1173/g | Refrigerator |
| Ex 15 | 31.3 | 25 | 17.8 | 10.7 | 4.5 | 10.7 | 30 Days |
| Comp T | 31.3 | 25 | 17.8 | 0 | 4.5 | 10.7 | 3 Days |
| Comp U | 31.3 | 25 | 17.8 | 10.7 | 4.5 | 0 | 3 days |
| Comp V | 31.3 | 25 | 17.8 | 0 | 4.5 | 0 | 0 days |

Example 15 demonstrates the synergistic affect on solubility of using both Irgacure 184 together with Darocur 1173 to form a ambient temperature stable system that contains EPD, Irgacure 369, ITX and BPO. The samples of Example 15 were made by weighing the individual ingredients into a glass container, and heating them in an oven at 60° C. Then samples were mixed by hand until 100 percent of the components were in a liquid state and the mixture was homogeneous. The samples were then allowed to cool to room temperature, and subsequently transferred to a refrigerator set at 11° C. The stability in days was the amount of time that elapsed in the refrigerator before any crystallization or other instability was noted in the mixture. The data in Table 10 clearly demonstrate the superior stability of the mixtures when Irgacure 184 and Darocur 1173 are used together.

A comparison of Examples 13 to 15 with prior art photo-initiator blends illustrate the surprising and unexpected advantages in using Irgacure 184 and Darocur 1173 together to form stable liquid photo-initiator blends of different chemical classes

TABLE 11A
Black Inks

| | | | | Irg | Irgacure | | Darocur |
|---|---|---|---|---|---|---|---|
| Sample | BDK % | EPD % | BPO % | 369% | 184% | ITX % | 1173% |
| Ex 16 | 25 | 25 | 0 | 25 | 0 | 25 | 0 |
| Ex 17 | 0 | 20 | 0 | 20 | 20 | 20 | 20 |
| Ex 18 | 0 | 25 | 0 | 25 | 12.5 | 25 | 12.5 |
| Ex 19 | 0 | 31.3 | 25 | 17.8 | 10.7 | 4.5 | 10.7 |

TABLE 11B
Black inks continued

| | stability at | | Shortness Index | Yield |
|---|---|---|---|---|
| | ambient | Stability | η @ 50 s⁻¹/ | Point |
| Sample | temperature | Days 11° C. | η @ 100 s⁻¹ | (Pa) |
| Ex 16 | Solidified | | 1.27 | 19 |
| Ex 17 | >7 days | 6 days | 1.27 | 8 |
| Ex 18 | <1 day | 5 days | 1.26 | 5 |
| Ex 19 | Indefinite | 30+ days | 1.00 | 0 |

The rheology data in Table 11 is for various inks made with formulations analogous to the ink in Example H of Table 6 herein but substituting each of the photo-initiator systems shown in Table 11 for the standard photo-initiator system used in the Comp G of Table 5. The ink made with Example 16 photo-initiator blend exhibits less good rheology, with a moderate shortness index and high yield point. In each of the subsequent sample inks made with the photo-initiator blends of Example 17 to 19, the Darocur 1173 and Irgacure 184 are substituted at different levels and in each case the rheological performance of the ink improved by lowering the yield point, the shortness index, or both. The best performance is obtained with Example 19 where the shortness index is equal to 1 and there is no (zero) yield stress, indicating nearly Newtonian flow conditions which is the ideal rheological profile for an ink to be used in flexography. This combination of photo-initiators also exhibits excellent stability. This improvement in rheology if completely unanticipated as it is commonly accepted that photo-initiators do not affect the rheology of pigmented systems.

1 A formulation comprising a mixture of three or more photo-initiators, the mixture being a liquid at a temperature at or below ambient; the mixture comprising:
(a) a first photo-initiator comprising an optionally substituted hydroxyC₁₋₁₀ alkylC₆₋₁₈aryl ketone which is liquid at ambient temperature;
(b) a second photo-initiator comprising an optionally substituted hydroxy(cycloC₃₋₁₀allkyl)C₆₋₁₈aryl ketone which is solid at ambient temperature; and
c) a third photo-initiator comprising one or more of the following photo-initiators each of which may be optionally substituted:
an alpha aminoacetophenone, a C₆₋₁₈aryl(((C₁₋₁₀alkyl)₁₋₄C₆₋₁₈arylcarbonyl))₁₋₃ phosphine oxide, a benzophenone; a benzophenone derivative and/or a hydrocarbo (optionally alkyl or aryl) amino benzoate; where,
(i) the first photo-initiator (a) and the second photo-initiator (b) are present in the mixture in a weight ratio of from about 0.8 to about 1.2,
(ii) the first photo-initiator (a) and the second photo-initiator (b) together comprise from about 15 to about 85 percent by weight of the total mixture.

2. A formulation as claimed in claim 1, in which the first photo-initiator (a) comprises a hydroxyC₁₋₆alkylC₆₋₁₂aryl ketone.

3. A formulation as claimed in claim 2, in which the first photo-initiator (a) comprises a hydroxyC₁₋₄alkylphenyl ketone.

4. A formulation as claimed in claim 3, in which the first photo-initiator (a) comprises 2-hydroxy-2-methyl-1-phenyl-1-propanone.

5. A formulation as claimed in claim 1, in which the second photo-initiator (b) comprises a hydroxy(cycloC₃₋₆alkyl)C₆₋₁₂aryl ketone.

6. A formulation as claimed in claim 5, in which the second photo-initiator (b) comprises a hydroxy(cycloC₃₋₆alkyl)phenyl ketone.

7. A formulation as claimed in claim 6, in which the second photo-initiator (b) comprises 1-hydroxycyclohexyl phenyl ketone.

8. A formulation as claimed in claim 1, in which the third photo-initiator (c) comprises a C₆₋₁₂aryl(((C₁₋₆alkyl)₂₋₃C₆₋₁₂arylcarbonyl))₁₋₂ phosphine oxide.

9. A formulation as claimed in claim 8, in which the third photo-initiator (c) comprises a phenyl((C₁₋₄alkyl)₃benzoyl)₂ phosphine oxide;

10. A formulation as claimed in claim 9, in which the third photo-initiator (c) comprises phenyl bis(2,4,6-trimethyl benzoyl) phosphine oxide.

11. A formulation as claimed in any preceding claim, in which the third photo-initiator (c) is solid at ambient temperature.

12. A formulation as claimed in any preceding claim, in which the weight ratio of the first photo-initiator (a) to the second photo-initiator (b) is from about 0.9 to about 1.1.

13. A formulation as claimed in claim 12, in which the weight ratio of the first photo-initiator (a) to the second photo-initiator (b) is about 1.0.

14. A formulation as claimed in any preceding claim, in which the first photo-initiator (a) and the second photo-initiator (b) together comprise at least about 60% by weight of the total mixture;

15. A formulation as claimed in claim 14, in which the first photo-initiator (a) and the second photo-initiator (b) together comprise from about 60% to about 75% by weight of the total mixture.

16. A formulation as claimed in any preceding claim, in which the third photo-initiator (c) comprises at least about 25% by weight of the total mixture

17. A formulation as claimed in claim 16, in which the third photo-initiator (c) comprises from about 25% to about 40% by weight of the total mixture.

18. A process comprising the steps of mixing together
(a) a first photo-initiator comprising an optionally substituted hydroxyC₁₋₁₀ alkylC₆₋₁₈aryl ketone which is liquid at ambient temperature;
(b) a second photo-initiator comprising an optionally substituted hydroxy(cycloC₃₋₁₀alkyl)C₆₋₁₈aryl ketone which is solid at ambient temperature; and
(c) a third photo-initiator comprising one or more of the following photo-initiators each of which may be optionally substituted:
an alpha aminoacetophenone, a C₆₋₁₈aryl(((C₁₋₁₀alkyl)₁₋₄C₆₋₁₈arylcarbonyl))₁₋₃ phosphine oxide, a benzophenone; a benzophenone derivative and/or a hydrocarbo (optionally alkyl or aryl) amino benzoate; where,
(i) the first photo-initiator (a) and the second photo-initiator (b) are present in the mixture in a weight ratio of from about 0.8 to about 1.2,
(ii) the first photo-initiator (a) and the second photo-initiator (b) together comprise at least about 60% by weight of the total mixture; and
(iii) the third photo-initiator (c) comprises at least about 25% by weight of the total mixture. to form mixture of three or more photo-initiators, said mixture being a liquid at a temperature at or below ambient.

19. A formulation obtained and/or obtainable by a process as claimed in claim 18.

20. A method of preparing a pigmented coating and/or ink comprising the steps of mixing a formulation as claimed in any of claims 1 to 17 or 19; with a suitable carrier medium and/or colorant.

21. A pigmented coating and/or ink as claimed in claim 20 having a shortness index less than or equal to about 10.

22. A pigmented coating and/or ink as claimed in claim 21, having a shortness index is less than or equal to about 5.

23. A pigmented coating and/or ink as claimed in claim 21, having a shortness index less than or equal to about 2.

24. A pigmented coating and/or ink as claimed in any of claims 20 to 23 with a yield point is less than or equal to about 10 Pa.

25. A pigmented coating and/or ink as claimed in claim 24, with a yield point is less or equal to about 5 Pa.

26. A pigmented coating and/or ink as claimed in claim 25, with a yield point less than or equal to about 2 Pa.

27. Use of a mixture of
(a) a first photo-initiator comprising an optionally substituted hydroxyC₁₋₁₀ alklyC₆₋₁₈aryl ketone which is liquid at ambient temperature;
(b) a second photo-initiator comprising an optionally substituted hydroxy(cycloC₃₋₁₀alkyl)C₆₋₁₈aryl ketone which is solid at ambient temperature as an additive to a pigmented coating and/or ink for the purpose of reducing the shortness index and/or yield point thereof.
